(19) United States
(12) Patent Application Publication
(10) Pub. No.: US 2003/0016196 A1
(43) Pub. Date: Jan. 23, 2003

(54) Thin film transistors suitable for use in flat panel displays

(75) Inventors: Ernst Lueder, Scottsdale, AZ (US); W. Edward Naugler, JR., Escondido, CA (US)

Correspondence Address: Aldo J. Test, DORSEY & WHITNEY LLP, Four Embarcadero Center, Suite 3400, San Francisco, CA, 94111-4187, US

(73) Assignee: Display Research Laboratories, Inc.

(21) Appl. No.: 10/187,350

(22) Filed: Jun. 28, 2002

Related U.S. Application Data
(60) Provisional application No. 60/306,362, filed on Jul. 17, 2001.
(60) Provisional application No. 60/306,366, filed on Jul. 17, 2001.
(60) Provisional application No. 60/306,368, filed on Jul. 17, 2001.
(60) Provisional application No. 60/306,367, filed on Jul. 17, 2001.
(60) Provisional application No. 60/306,363, filed on Jul. 17, 2001.

(51) Int. Cl. G09G 3/32

(52) U.S. Cl. 345/82

(57) ABSTRACT

A flat panel display is described. The flat panel display includes a matrix of light-emitting diodes which are driven by thin film field effect transistor circuits in which the channel electrodes of the field effect transistors are cadmium selenide or cadmium telluride. The cadmium selenide or cadmium telluride contains fluoride ions to enhance the mobility. A non-oxygenated layer is applied to the channel electrodes.

### RELATED APPLICATIONS

This application claims priority to the following United States Provisional Applications: Serial Nos. 60/306,362; 60/306,366; 60/306,368; 60/306,367; and 60/306,363 all of which were filed on Jul. 17, 2001.

### BRIEF DESCRIPTION OF THE INVENTION

This invention relates generally to thin film transistors for use in flat panel displays and more particularly to thin film transistors using cadmium selenide or cadmium telluride as the active semiconductor material in pixel and peripheral drive circuits. The invention also relates to a method of inexpensively fabricating flat panel display pixel and peripheral drive circuits.

### BACKGROUND OF THE INVENTION

A flat panel display consists of rows and columns of pixels that determine the resolution of the image. The contrast, color and pattern are controlled by the brightness and color of each individual pixel. The number of rows and columns in present day flat panel displays can vary from a few columns and a few rows for alphanumeric displays found in watches, radios and entertainment equipment to thousands of rows and columns found in high-density television and high-resolution graphics displays.

For example, a typical VGA display has 640 times three colors (red, green and blue) columns and 480 rows of pixels for a total count of 921,600 pixels. Thin film sample and hold circuits are associated with each pixel to receive a voltage signal representing the image input data and store it at each pixel as the data is scanned into the display. The voltage value is applied to a power FET (field effect transistor), which controls current or voltage to the pixel imaging material.

FIG. 1 schematically shows a typical flat panel display. The display includes a substrate 11 onto which pixels including light emitting diodes and associated drive circuits are formed to provide the display area 12. The pixels are arranged in columns and rows. Row shift register 13 is connected to the rows by lines 14. Each column is connected to column shift registers 16 by lines 17. Clock, power and data signals are fed to the display via lines 18 to shift register controller 19. Controller 19 feeds column data to the column shift register 16. The controller then sends clock signals to the first row of row shift register 13, enabling the downloading of the data in shift register 18 to the first line of the display. Data for line two of the display then replaces the line one data in the column shift register, which is then downloaded to row two. This procedure continues down the entire display row by row for a frame of data and is then repeated for the next frame of data. The drive circuitry is well known in the industry and is not shown in the drawing.

Referring to FIG. 2, each pixel of the active matrix displays includes light-emitting diodes 21 driven by a circuit including transmission gate FETs 22, storage capacitors 23, and power FETs 24. The drain of each power FET 24 is connected to the anode of the light-emitting diode (LED) 21. The cathode of LED 21 is connected to ground. In operation, signal data is stored line by line in column registers 16. The register comprises two parallel registers, one which feeds the odd column lines and the other which feeds the even lines. Which pixel is to receive the data from the buffers is determined by row register 13. As the signal data arrives at the matrix, first register 16a is filled with the first line of the display frame. When the complete first line is in register 16a, the row selector places a signal on the first row line 13. This row signal opens all the transmission gates 22 in the first row and the data stored in register 16a is downloaded and stored as a voltage in storage capacitor 23 of each pixel. The total storage capacitance is the sum of the metal connection lines, the gate capacitance of output FET 24, and the capacitance of the storage capacitor 23. The storage duration is determined by the RC time constant calculated by the reverse resistance of transmission gate 22, plus the storage capacitance 23, leakage resistance times the total storage capacitance. The storage RC constant should be at least three times the frame duration in time. For example, if the signal data consists of sixty (60) frames per second, the frame duration time is 16.7 ms and the RC constant should be 49.5 ms or greater. Therefore, frame rate plus the total reverse leakage resistance determines the size of the total storage capacitance.

The voltage level +V and duration placed on the gate of output FET 24 determines the perceived brightness of LED 26. This means that there are two ways to effect brightness. The first is by storing the value of voltage level of the display voltage on storage capacitor 23. The second way is to break the display frame into eight (8) binary sub-frames that can be combined in 256 ways to give varying time durations of the voltage signal on storage capacitor 23. This is called 8-bit gray scale.

As one can see, the switching quality of the transmission gate FETs 22 and the power capability of power FETs 24, FIG. 2, are critical. Switching quality is determined by the on resistance of the transmission gate FETs 22 divided into the off (leakage) resistance of the transmission gate FETs 22.

Present materials used to fabricate active matrix transmission gates and power transistors are amorphous silicon (a-Si) and polysilicon (p-Si). These popular materials for making thin film circuits are difficult to use, make low performance switches, have low power capability, and require manufacturing temperatures too high for compatibility with plastic substrates. The integrated circuit industry early-on settled for single crystalline silicon as the standard semiconductor material, but single crystalline (monolithic) silicon could not be used for the active matrix in an LCD, because the display had to be spread over the larger area than an IC could cover. Today, a-Si is used in all laptop and notebook high-resolution color displays and is also making inroads into the computer desktop monitor market. In the case of high-resolution displays, the rows and columns are so close together that making the thousand interconnections from the display to the computer control circuits is difficult. Note that the VGA color display has 1920 RGB columns and 480 rows for a total of 2400 connections. In order to eliminate most of these connections, the display driver circuitry 13, 16 must be placed on the same glass plate using the thin film semiconductor used in the pixel circuitry. By placing the driver circuitry on the glass substrate with the pixel circuits the connections to the computer are reduced to only a couple dozen lines 18. The advantage is that, while the pixel circuit operates at fairly low speed (in the kilohertz range), the driver circuits operated in the megahertz range, a thousand times faster than a-Si, can handle.

The speed of a semiconductor increases as the material progresses from amorphous to single crystalline. The industry could not use single crystalline silicon (x-Si) so it decided to convert the a-Si to poly-crystalline silicon (p-Si) using heated annealing steps. In the beginning the industry did this by depositing p-Si on quartz plates heated to 900 degrees Centigrade. Quartz, however, is too expensive for most display applications; thus, methods were developed to create p-Si from a-Si using laser anneals which would locally heat the deposited a-Si to high temperature, but would not heat the glass substrate to the melting point. This method produced p-Si with enough speed to put the drivers on the glass substrate. The cost, however, was still high due to the cost of high-powered lasers. P-Si is a much different material than a-Si. For one thing a-Si does not have to be doped the way Si in the IC industry has to be, but p-Si does require dopants to produce the desired electrical contact characteristics. P-Si also does not make a very good on off switch. P-Si is very difficult to make uniformly due to the scanning of the laser anneal. These problems with p-S have to be compensated for by more elaborate circuitry. The fabrication processes employed are expensive and have low yields.

For displays that use light-emitting diodes, the active matrix is not just a carrier of data, but now must carry the power that produces the light by which one sees the display. A-Si is not an option and the industry has turned to p-Si, which has the performance capability to run emissive displays.

The newest emissive displays are the field emission display (FED) and the organic light-emitting diode display (OLED) sometimes misnamed the organic EL or OEL. The present organic materials are all diodes, and thus, make OLEDs. There are several types of OLED materials. The first was invented at Kodak in the 1980s and is referred to as the small molecule OLED. Later, polymer OLED and metallo-organic material were invented. All of these display types including the FED require an active matrix to reach their full potential in resolution and image quality.

Kodak in partnership with Sanyo produced the first active matrix OLED display using p-Si for the pixel circuitry and also for drivers on the glass substrate. At the present time many companies are developing active matrix OLEDs using the standard p-Si circuitry developed by several companies in the industry over the last 15 years. In order to compensate for the problems of p-Si, special pixel drive circuits were designed. Such circuits are described in the paper entitled “Poly-Si Driving Circuits for Organic EL Displays,” paper 4925-20, Conference 4925A, Electronic Imaging 2001, San Jose, Calif. This paper explains the problems caused by the varying threshold voltages in a p-Si active matrix. The paper also alludes to other variances such as electron mobility variance across the matrix array. Because of these problems, it is unlikely that p-Si active matrixes will be applied to large (>15-inch) OLED displays, and that an alternative solution is necessary.

Copending application Ser. No. 09/952,777 filed Sep. 14, 2001 describes a thin film transistor which employs cadmium selenide as the semiconductor active layer. Using the improved transistor structure allows the formation of flat screen displays in which the pixels, pixel drive circuits and the peripheral drive circuits are formed in the same steps on a supporting suitable substrate.

A very important parameter of a thin film transistor is the electron mobility μ_{eff} that determines the channel current characteristic of the thin film transistor. A high μ_{eff} means that the resulting thin film transistor (TFT) will have a high speed and power, which are requirements for driving emissive displays, such as the new organic light-emitting diode (OLED) displays. It is desirable to produce OLED displays on plastic substrates, which have a low melting temperature. This means that the semiconducting material forming the channel must obtain a high μ_{eff} at very low temperature. It has been possible to obtain 60-100 cm²/volt-sec in cadmium selenide and cadmium telluride on plastic substrates. While this μ_{eff} may be enough to produce the pixel transistors for active matrix displays, it is marginal for drive circuits.

### OBJECTS AND SUMMARY OF THE INVENTION

It is an object of the present invention to provide cadmium selenide or cadmium telluride TFTs having high electron mobility that are processed at temperatures compatible with plastic substrates and other substrates.

It is another object of the present invention to provide a process employing cadmium selenide and cadmium telluride inks and pastes for fabricating active matrix circuitry used to drive the pixels and/or control drivers for any type of flat panel display.

It is a further object of the present invention to provide a TFT have a cadmium selenide or cadmium telluride channel with high electron mobility.

It is still a further object of the present invention to provide a cadmium selenide or cadmium telluride ink or paste suitable to form the semiconducting element of TFTs by ink jet printing or screen printing.

This invention provides a thin film transistor formed with a cadmium selenide (n-type) or cadmium telluride (p-type) channel. The channel can be formed and patterned by silkscreen printing or ink jet printing a paste or ink layer comprising a suspension of cadmium selenide or cadmium telluride particles in a carrier and heat-treating the layer to consolidate the particles to form the channel. Introducing fluoride ions into the channel increases the electron mobility of the channel. The thin film transistor with improved mobility can be used to drive LCDs or light-emitting diodes including organic light-emitting diodes and also for control drive circuits associated therewith.

### BRIEF DESCRIPTION OF THE DRAWINGS

The invention together with its advantages will be better understood by reference to the following description together with the accompanying drawings in which:

FIG. 1 schematically shows a typical flat panel display.

FIG. 2 is a schematic diagram showing four pixels of a flat panel display and their control and drive circuits.

FIG. 3 is a cross-sectional view of a thin film transistor in accordance with the present invention.

FIG. 4 is a cross-sectional view of a thin film transistor in accordance with the present invention connected to drive a light-emitting diode.

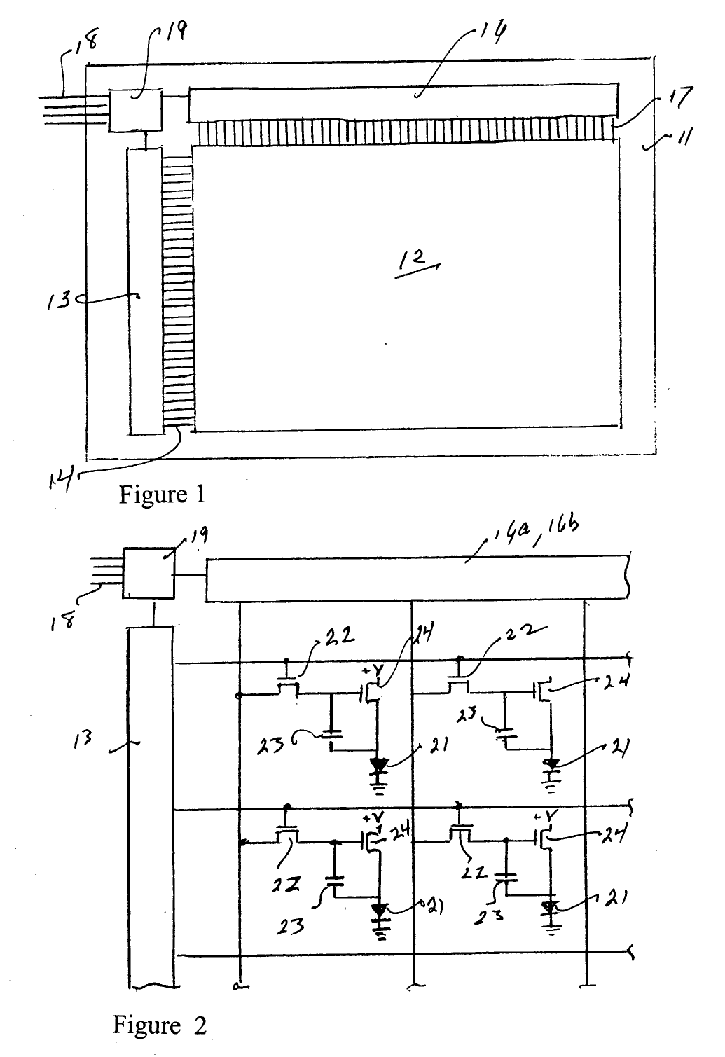

### DESCRIPTION OF THE PREFERRED EMBODIMENT

In accordance with the present invention, a suitable substrate is chosen according to the application of the flat panel display. For example, for a flexible substrate, Kapton or PES plastic is used. For other types of displays, glass or insulated metal substrates can be used. In most displays using light-emitting diodes, the light is emitted down through the substrate so the substrate must be made of transparent material.

In the fabrication of a flat panel display, it is advantageous to employ thin film transistors in which the semiconductor material can be processed at lower temperatures compatible with the substrates whereby pixel drive thin film transistors and control register and buffer transistors can be fabricated at the same time.

In accordance with one feature of the present invention, the active semiconductor material is cadmium selenide which includes electron mobility enhancing ions such as fluoride ions whereby the TFTs have the speed required for the shift registers, buffers and other control circuits.

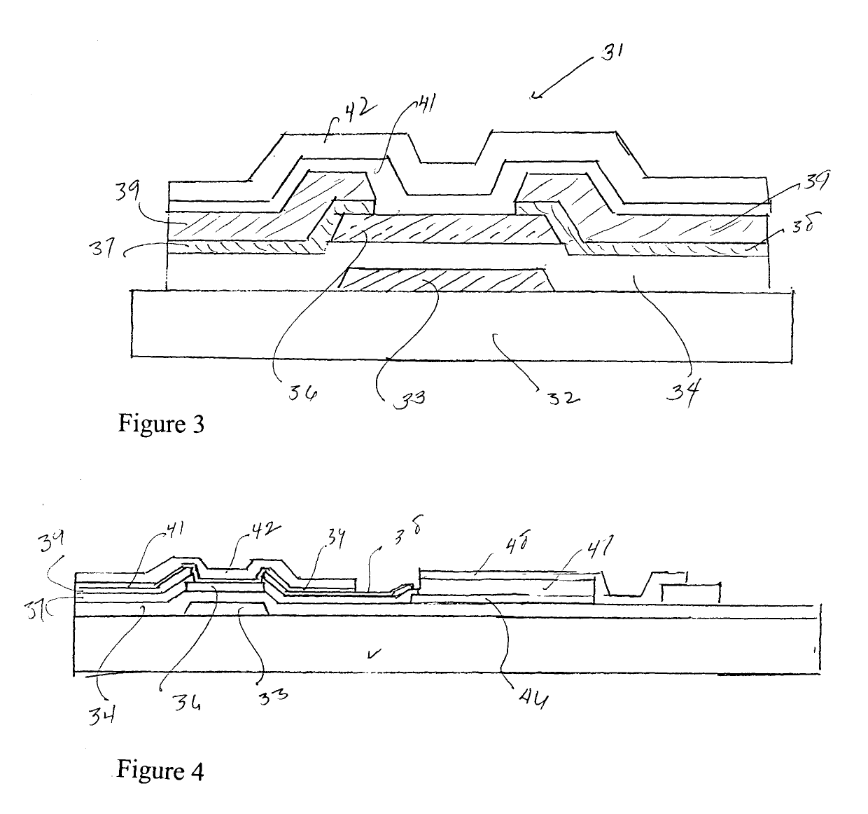

FIG. 3 is an enlarged sectional view of a thin film transistor 31 having a cadmium selenide semiconductor channel layer. The thin film transistor is described by describing its fabrication. A metal film, preferably chromium, is deposited on the transparent substrate 32. Gate electrodes 33 are defined on the surface of the substrate by masking and etching the film in accordance with techniques well-known in the industry. Next, a gate dielectric layer 34 is deposited and patterned over the gate electrodes 33. The gate dielectric can be silicon dioxide, silicon nitride, titanium oxide or other dielectric material. In one embodiment, the next steps are to (1) deposit a layer of cadmium selenide as, for example, by sputtering, to provide uniform properties over the channel area, and (2) to mask and etch to define channel regions 36. The cadmium selenide layer is then thermally annealed by heating to obtain a coherent semiconductor material in which the cadmium selenide crystals are in intimate contact. Source 37 and drain electrodes 38 are formed by depositing a layer of chromium and masking and etching to form electrodes. An aluminum layer 39 may be deposited on the chromium layer prior to the masking and etching which defines the source and drain electrodes.

In the prior art, an oxide passivating layer has been deposited over the entire structure to seal the cadmium selenide from the environment which contains both water and oxygen. Thin film transistors employing cadmium selenide as the active semiconductor material and including a silicon dioxide passivation layer have lacked long-term stability because the passivation layer contains oxygen which reacts with the selenium in the cadmium selenide. In accordance with one embodiment of the present invention, a non-oxygenated passivation layer 41 such as silicon nitride is interposed between the silicon oxide passivation layer 42 and the cadmium selenide channel 36.

However, we have found that the electron mobility of the cadmium selenide channel is increased by a factor greater than two if fluoride ions are introduced into the cadmium selenide. This can be accomplished by introducing a small amount of fluorine gas during the deposition of the cadmium selenide layer prior to the heat treatment. Alternatively, a thin layer contains magnesium fluoride, lithium fluoride or other fluoride salt which provides fluoride ions which migrate into the cadmium selenide channel 36 during heat treatment.

The thermal anneal at, e.g. 280° C., causes fluoride ions to diffuse into the grain boundaries of CdSe where they saturate traps lowering the potential barrier and thus enhancing the flow of the drain-source current, I_{d}. This reflects in a higher mobility, μ. This is because the bonds between Cd or Se and F are very strong, stronger than the bonds to H, which is commonly used. One also obtains an improved stability over a longer time. The thermally induced doping with MgF₂ or LiF is much easier to achieve than laser beam induced doping or in situ doping from a mixture of gases. The beneficial effects of MgF₂ doping allow for larger fluctuations of the process parameters such as Ar pressure, content of impurities in the vacuum such as water and oxygen, sputter power and as flows. This significantly reduces fabrication cost and enhances fabrication yield.

MgF₂ serves as a barrier between the passivation layer, which otherwise contains O₂, and the CdSe, which degrades when oxidized. The passivation layer is, however, needed, as the thin MgF₂ layer is not a good enough protection against diffusions and mechanical damage. A thicker MgF₂ is not feasible, as it tends to become brittle. The barrier layer, MgF₂, allows for the free selection of passivation dielectrics on the top of it even if they contain O₂, which used to degrade the transmitter mobility without MgF₂ and even if they are sputtered, which used to generate an unwanted doping of CdSe without the MgF₂ barrier. With this barrier all most frequently used deposition methods for CdSe such as APCVD, PECVD, sputtering or evaporation can now be used.

In accordance with another aspect of the invention, an alternate process may be employed to form the cadmium selenide channel region. An ink or paste, which includes cadmium selenide particles suspended in a carrier, can be deposited in the channel area to form the channel region 36. The cadmium selenide suspension can include magnesium fluoride or other fluoride salt which provides fluoride ions to enhance the mobility, or the ions can migrate from a non-oxygenated layer which includes fluoride ions. The ink or paste is applied to the defined areas above the gate electrodes by ink jet printing or by silk screening. Thereafter, the layer is dried and heated to consolidate the particles and form the cadmium selenide channel layer 36. Adding the non-oxygenated layer and passivation layer completes the process. It is seen that this process reduces the number of steps required to form the channel regions.

The ink or paste comprises nanoparticles of cadmium selenide or cadmium telluride salts. Nanoparticles have sizes ranging from less 1 to 999 nm. Methods of preparing CdSe nanoparticle inks, depositing of nanoparticle inks on a substrate, and immobilizing the nanoparticles on a substrate are discussed in U.S. Pat. No. 6,294,401. In general, semiconducting particles or nanoparticles may be monodisperse or polydisperse. They may form stable colloids in appropriate dispersing media as is well-known in the art of rheology, facilitating their deposition and processing in a liquid state. For smaller nanoparticles, a depression of the melting point can be observed, which facilitates the subsequent heat annealing step. In many cases, it is preferable to derivatize the surface of the nanoparticles or particles. However, heavy capping groups can be undesirable if they become trapped in the semiconducting film after ink application. Various methods are being developed to cover the surface of nanoparticles and particles with weak capping groups. Various processes are available for ink deposition including: ink jet printing, spin coating, casting, lithography, gravure printing, screen printing, impact printing, stamping and contact printing. Processes for applying dry inks include: dry jetting, laser printing and electrophotography. In any event, after the ink or paste is deposited in the channel areas, it is dried to evaporate the suspension carrier or medium and then heat treated to consolidate the cadmium selenide particles to form a continuous semiconductor layer. The particles shrink together to form intimate contact between particles. The film is annealed to obtain the desired electrical properties.

As described above, fluoride ions can be introduced after the ink or paste is deposited or preferably they are incorporated in the cadmium ink formulation by introducing a fluoride salt such as magnesium fluoride or other fluoride salt which is compatible with the ink medium.

The foregoing description of the formation of TFTs has been directed to the use of cadmium selenide an n-type material. It should be understood that cadmium telluride, a p-type material, can be used in the fabrication of TFTs in accordance with the present invention, and that the foregoing processes are equally applicable to cadmium telluride.

FIG. 4 shows the fabrication of a thin film power transistor and light-emitting diode which it drives. A transparent ITO anode 46 is formed on the gate dielectric prior to the formation of the cadmium selenide channel 36. The drain electrode 38 of the thin film transistor connects to the anode 46 of the light-emitting diode. An OLED material 47 is deposited on the anode followed by the deposition of a cathode 48, which may be a reflecting metal layer. With reference to FIG. 2, the anode is connected to the voltage source +V via the channel 36. The cathode is connected to ground and the gate is connected to the drain of the TFT 22.

Thus, there have been provided thin film transistors which can be employed in pixel drive circuits and the control circuits of flat panel displays, particularly displays employing OLEDs and FEDs. The transistors can be economically fabricated at low processing temperatures with minimum processing steps.

What is claimed is:

1. A flat panel display comprising
a plurality of display pixels including light-emitting diodes,
a matrix of thin film transistors for driving said light-emitting diodes, each thin film transistor including a gate, source, drain and channel electrode characterized in that said channel electrode comprises cadmium selenide or cadmium telluride doped with fluoride ions.

2. A flat panel display as in claim 1 in which the matrix of display pixels is arranged in columns and rows on a substrate and in which the column and row transistors are driven by column and row drive transistor circuits carried by the same substrate and in which the drive transistors include cadmium selenide doped with fluoride ions as the active semiconductor.

3. A flat panel display comprising a matrix of rows and columns of light-emitting diodes formed on a substrate,
a thin film transistor circuit associated with each light-emitting diode comprising a first thin film field effect transistor having its source, channel and drain electrodes in series with said light-emitting diodes between a voltage source and a common electrode, a second thin film field effect transistor having its source, channel and drain electrodes with the drain connected to the gate electrode of the first field effect transistor and the source electrode adapted to be connected to a column control voltage and a gate electrode adapted to be connected to a line control voltage,
said first and second transistors having cadmium selenide channels doped with fluoride ions, and a capacitor connected between the drain electrodes of said first and second thin film transistors.

4. A flat panel display as in claim 3 including row and column drive circuits carried by the substrate, said drive circuits including thin film transistors which have cadmium selenide doped with fluoride as the active semiconductor.

5. A flat panel display comprising
a matrix of light-emitting diodes,
a matrix of thin film field-effect transistor circuits for driving said light-emitting diodes characterized in that said field effect transistors have cadmium selenide or cadmium telluride channels doped with fluoride ions.

6. A flat panel display as in claim 5 in which said light-emitting diodes are organic light-emitting diodes.

7. A flat panel display as in claim 5 in which said light-emitting diodes are field emission diodes.

8. A thin film transistor comprising gate, source and drain electrodes, a deposited cadmium selenide or cadmium telluride channel and a silicon dioxide passivation layer characterized in that the cadmium selenide or cadmium telluride channel includes fluoride ions to increase the electron mobility in the channel.

9. A thin film transistor as in claim 1 in which the fluoride ions are introduced into the cadmium selenide or cadmium telluride during deposition.

10. A thin film transistor as in claim 8 or 9 including a non-oxygenated insulating layer between the channel and a passivation layer.

11. A thin film transistor as in claim 10 in which the noted layer includes fluoride ions which migrate into the cadmium selenide or cadmium telluride channel.

12. A thin film transistor as in claim 10 in which the non-oxygenated layer is silicon nitride.

13. A thin film transistor as in claim 10 in which the non-oxygenated layer is magnesium fluoride.

14. The method of fabricating a thin film transistor of the type which includes the gate, source and drain electrodes and a channel of semiconductor material between the source and drain electrodes comprising the steps of:
depositing a patterned gate metal on a substrate,
depositing a layer of gate dielectric material on the patterned gate metal,
applying a semiconductor suspension comprising cadmium selenide or cadmium telluride particles suspended in a carrier on the dielectric layer above the patterned gate metal,
heat treating the deposited suspension to drive off the carrier and leave a compacted continuous cadmium selenide or cadmium telluride channel layer,
depositing gate and drain electrodes in a pattern to contact to the ends of the channel, and
depositing a passivation layer over the source and gate electrodes and the channel.

15. A method as in claim 14 which includes the additional step of depositing a non-oxygenated layer in contact with the channel prior to depositing the passivation layer.

16. A method as in claim 15 in which the non-oxygenated layer includes fluoride ions which migrate into the channel.

17. A method as in claim 14 or 15 in which the semiconductor suspension includes fluoride ions.

18. A method as in claim 14 in which the semiconductor suspension has a viscosity such that it is deposited by ink jet printing on the gate dielectric above the patterned gate metal.

19. A method as in claim 14 in which the semiconductor suspension has a viscosity such that it is deposited by silk screening on the gate dielectric above the patterned gate metal.
